(19) United States
(12) Patent Application Publication
(10) Pub. No.: US 2012/0325022 A1
(43) Pub. Date: Dec. 27, 2012

(54) PRESSURE SENSING LIQUID LEVEL SENDER

(75) Inventors: Robert E. Shanebrook, Bradenton, FL (US); Colin B. Jury, Sarasota, FL (US); Michael F. Maddi, Lakewood Ranch, FL (US); Gary R. Flynn, Sarasota, FL (US)

(73) Assignee: VEETHREE

(21) Appl. No.: 13/168,402

(22) Filed: Jun. 24, 2011

(51) Int. Cl. G01L 1/02

(52) U.S. Cl. 73/862.581

(57) ABSTRACT

Measuring container fluid levels and fluid volumes using pressure sensors. An immersion tube is used to detect and convey the pressure at a bottom of a container, and a sender circuit converts the pressure into a liquid level or liquid volume. The sender circuit is isolated from the fluid container for fuel applications using corrosion resistant elastomers.

### BACKGROUND

Liquid level sensing units, or senders, often use float devices and mechanical connections to a potentiometer. The float is used to detect the liquid level, and its position is detected by contacts on the float that slide along the potentiometer to alter the measured resistance. A gauge provides a display of the fluid level based on the amount of current flowing through the potentiometer of the sender. These systems often conform to standardized signal levels and/or digital communication formats, such as those specified by the Society of Automotive Engineers (SAE) (e.g., Truck and Bus Control and Communications Network Standards set forth in SAE-J1939; SAE J1810 Electrical Indicating System Specification), or by the National Marine Electronics Association (NMEA 2000).

### SUMMARY

Described herein are methods and apparatuses for measuring container fluid levels and fluid volumes using pressure sensors. An immersion tube is used to detect and convey the pressure at a bottom of a container, and a sender circuit converts the pressure into a liquid level or liquid volume. In one embodiment, a fluid sender device comprises a pressure transducer configured to generate a pressure measurement; an immersion tube coupled to a port of the pressure transducer, and the other end of the tube configured for receiving a pressure from a fluid in which it is immersed, and the tube serving to communicate the pressure to the port; a sender circuit connected to the pressure sensor, the sender circuit configured to provide a sender output that varies in response to the pressure measurement; and, a housing configured to enclose the pressure transducer and the sender circuit, the housing further configured to provide electrical isolation between the port and the sender circuit, the housing having a mounting structure configured to mount the housing to a wall of a fluid container with the immersion tube extending into an interior of the fluid container.

Embodiments described herein also include methods, such as a method comprising: sensing a first pressure at a container bottom position at an interior portion of a fluid container using an immersion tube; sensing a reference pressure; generating a differential pressure signal in response to the first pressure and the reference pressure; generating a volumetric signal based on volumetric data the differential pressure signal; and, generating a sender output signal from a sender circuit in response to the volumetric signal wherein the sender circuit is enclosed in a housing providing electrical isolation from the interior portion of the fluid container.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The accompanying drawings, which are incorporated in and constitute part of this specification, illustrate embodiments of the invention and together with the description serve to explain the principles of the present disclosure. The embodiments illustrated herein are presently preferred, it being understood, however, that the invention is not limited to the precise arrangements and instrumentalities shown, wherein:

FIG. 1 depicts an exploded view of the fluid sender apparatus;

FIGS. 2A and 2B depict two embodiments of the fluid sender apparatus with different mounting structures;

FIG. 3 depicts a cross sectional view of a fluid sender embodiment;

FIG. 4 depicts a cross sectional view of an alternative embodiment of a fluid sender; and,

FIG. 5 depicts a flow chart of a fluid sender method.

### DETAILED DESCRIPTION

In the following detailed description, reference is made to the accompanying drawings, which for a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of difference configurations, all of which are explicitly contemplated herein. Further, in the following description, numerous details are set forth to further describe and explain one or more embodiments. These details include system configurations, block module diagrams, flowcharts (including transaction diagrams), and accompanying written description. While these details are helpful to explain one or more embodiments of the disclosure, those skilled in the art will understand that these specific details are not required in order to practice the embodiments.

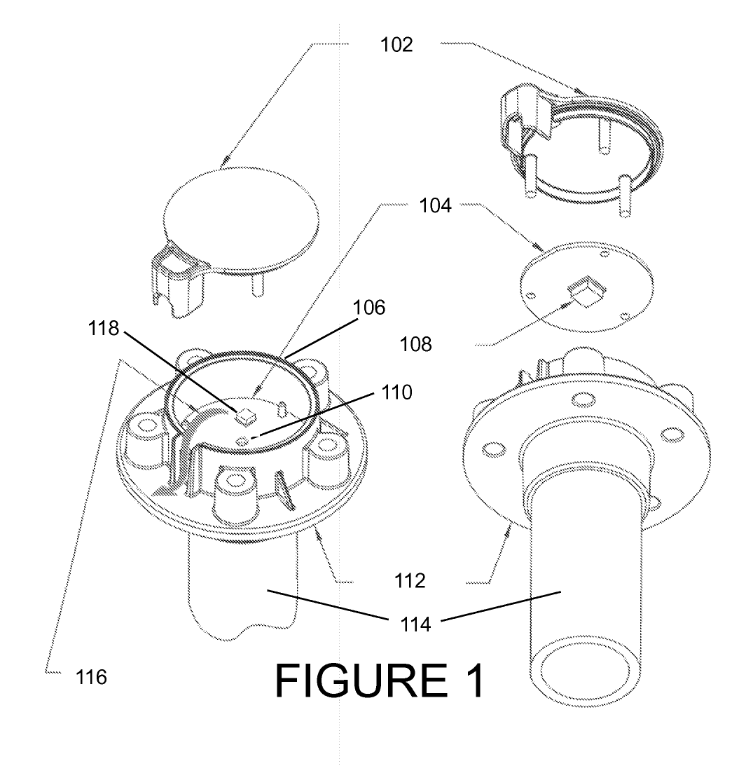

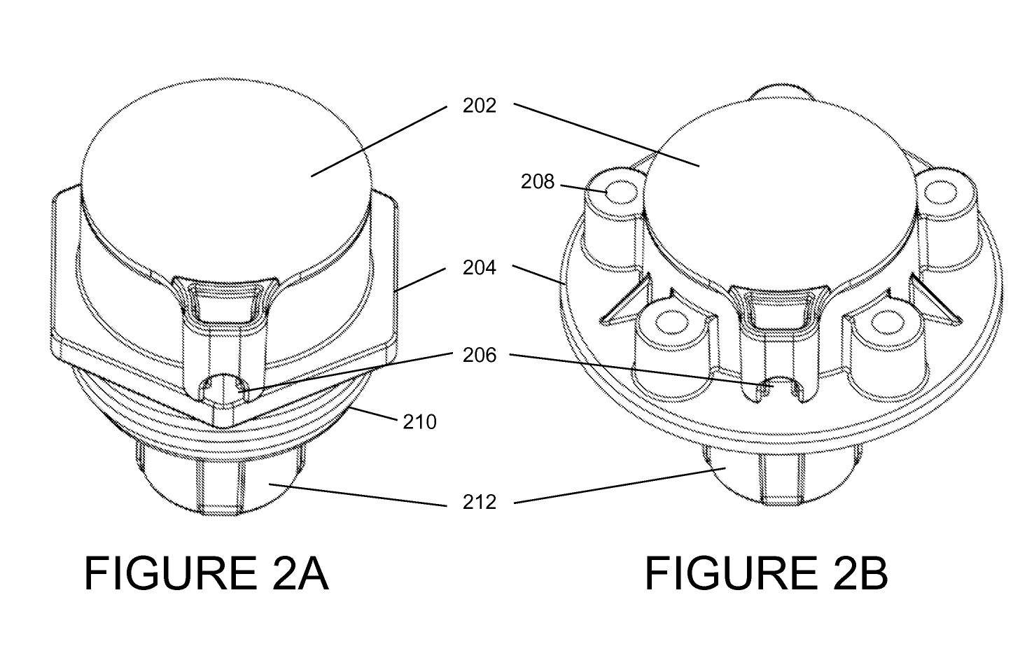

As shown in FIG. 1, the fluid sender includes a housing that includes the housing base 106 and housing cover 102 for housing the sender circuit mounted on the printed circuit board (PCB) 104, also referred to as a printed wiring assembly (PWA). The housing is configured to enclose the pressure transducer and the sender circuit, and to provide electrical isolation between the transducer port and the sender circuit. The housing also includes a mounting flange 112 that is configured to mount the sender apparatus to a fluid container, or tank, such as a fuel tank. FIGS. 2A and 2B depict two embodiments of the mounting structures for mounting the fluid sender to the fluid container. Specifically, FIG. 2A depicts a housing structure that includes a flange with a threaded 1½ NPT cylinder, and FIG. 2B depicts a flange having an SAE 5 hole mounting pattern.

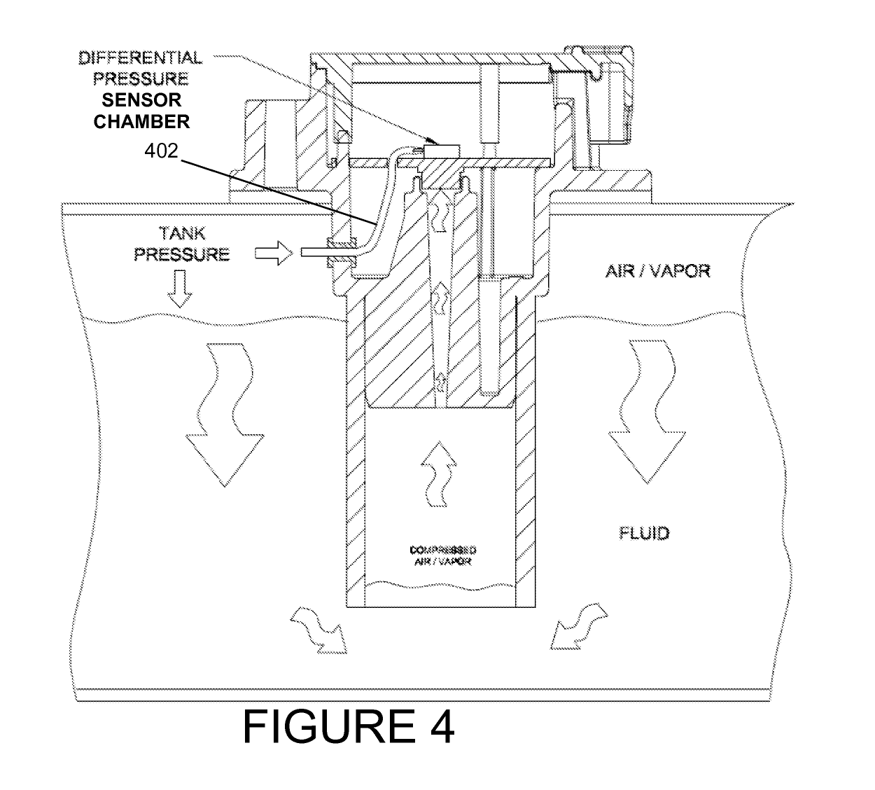

The pressure sensor or transducer 108 is mounted to the PWA 104, as is the sender circuit 118. In some embodiments, the pressure transducer is a differential transducer that includes a reference port, and the housing includes a reference passage configured to expose the reference pressure port to a reference pressure. Note that the PWA 104 includes an orifice 110 that exposes the reference port of the transducer 108 to the ambient pressure as indicated by arrow 116. In an alternative embodiment shown in FIG. 4, a container reference tube 402 and a sensor chamber is provided to connect the reference port to the interior of the container via the orifice 110.

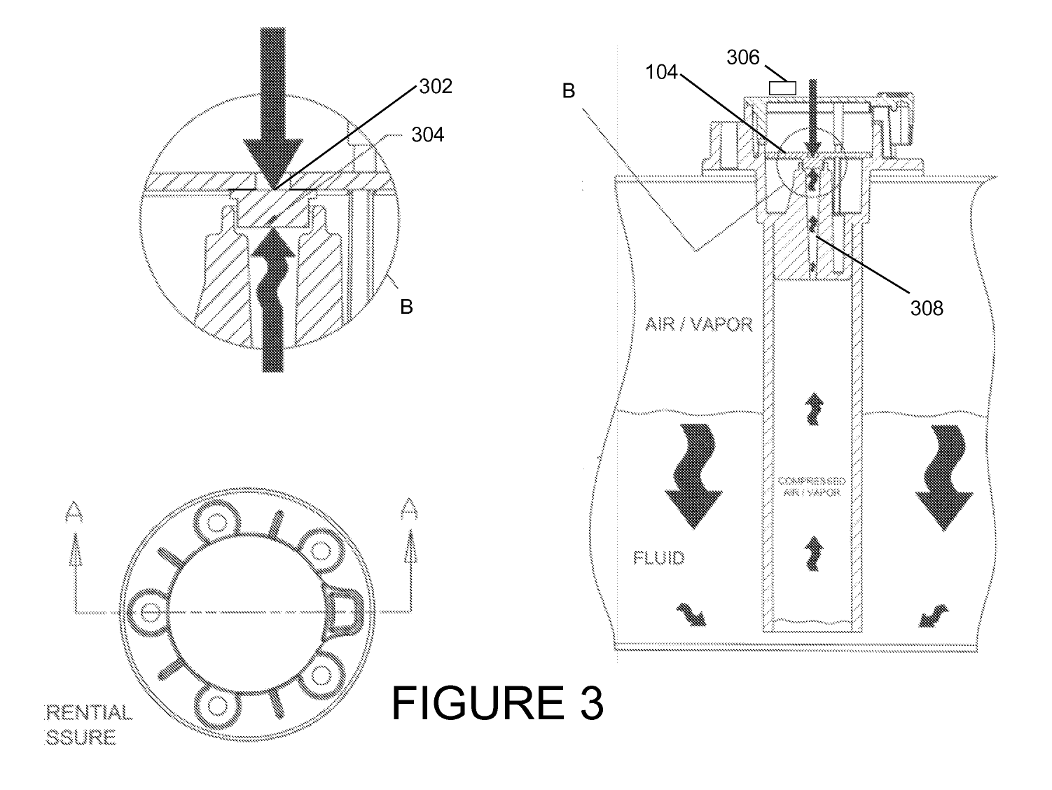

The immersion tube 114 is connected to the bottom of the housing such that the pressure in the tube is communicated to a main port of the pressure transducer. In operation, the immersion tube extends into a fluid container and is immersed in the fluid to be measured. The immersion tube 114 contains atmospheric gases and fluid vapors, and the pressure associated with the gases inside the tube 114 increases as the fluid level increases, as depicted in FIGS. 3 and 4. In this manner, the immersion tube 114 communicates the pressure associated with the bottom of the immersion tube, which is located at or near the bottom of the fluid container (or at whatever location is desired to be associated with the bottom of the fluid container for purposes of indicating an “empty” condition). The housing includes a passage 308 for communicating the pressure of the immersion tube to the main port of the pressure transducer. In the embodiment shown, the passage has a narrow opening to prevent fluids in the interior of the tube from splashing onto the transducer. The passage 308 is tapered to increase its diameter as it nears the transducer. The passage 308 further includes a recessed area to accept the pressure transducer. A sealant may be used to seal the gap between the transducer and the housing passage to ensure the pressure within the immersion tube does not leak past the transducer. The sealant may be an elastomer rated for use with hydrocarbon fuels such as gasoline, diesel fuel, etc. Furthermore, the immersion tube may be glued or spin-welded to the housing to ensure that the pressure inside the immersion tube does not leak.

As shown in cross-section A-A of FIG. 3 (and the blown-up portion B), the pressure transducer 108 is configured to generate a pressure measurement based on the pressure differential between the main port 304 and the reference port 302. The sender circuit 118 is connected to the pressure transducer 108, and the sender circuit is configured to provide a sender output that varies in response to the pressure measurement.

In one embodiment, the sender circuit may include a microprocessor and analog-to-digital converter (ADC) for detecting the voltage output of the pressure transducer. The output of the ADC may be periodically read by the microprocessor. Alternative embodiments may include a microcontroller that contains an ADC, or in a further alternative embodiment, a digital counter may cause the output of a digital-to-analog converter (DAC) to increase, and a comparator may detect when the output of the DAC equals the transducer voltage output, thereby causing the microprocessor to read the counter value at that point. The sender circuit may also take the form of an Application Specific Integrated Circuit (ASIC), or Field Programmable Gate Array (FPGA). In some embodiments, the sender circuit includes memory devices for storing program instructions and/or pressure conversion data tables.

The sender circuit 118 may be configured to generate a sender signal representing a level of fluid in the fluid container. The level value may be determined based on a pressure to level conversion table. Because the pressure-to-level relationship will vary depending on the type of fluid (i.e., the specific gravity of the fluid), the table conversion data may be fluid specific. In some embodiments, the sender circuit may include a fluid selection switch that allows the fluid type to be specified. The selection switch may take the form of a DIP switch that is read by the microprocessor to determine which conversion table to use. Alternatively, the DIP switch may set the base address of a memory device used to store the conversion table data.

In other embodiments, the sender circuit 118 may be configured to store volumetric data corresponding to the fluid container and to generate a sender signal representing a volume of fluid in the fluid container based on the volumetric data and the pressure measurement. The conversion may be done in a single step by directly relating the pressure to a volume value from a table, or by direct calculation of the volume using a three-dimensional container model. In this case, the sender circuit may include a look-up table configured to convert the pressure measurement to a volumetric value corresponding to the container volume at that level. In an alternative embodiment, the conversion may be performed in multiple stages such as by converting the pressure to a liquid level value, and then converting the level value to a corresponding volumetric value based on the container dimensions or other volumetric data. Note that a two-step conversion, such as by sequential or cascaded table look ups, facilitates the use of many different tank or container shapes. Volume data may be provided by the tank manufacturer, and may be initially provided in the form of three-dimensional model, or container dimensions, from which volume values at various levels may be calculated and loaded into the appropriate tables.

In further embodiments, the sender circuit 118 may receive an input from a level sensor 306. The sensor may be mounted to the housing and be connected to the sender circuit and be configured to provide an angular-level measurement to the sender circuit. It may also be mounted on the PWA, or other portion of the sender apparatus. The level sensor may be an accelerometer, gyroscopic accelerometer, or one or more electro-mechanical liquid switches, or a single switch with multiple contacts, or other suitable level-sensing device.

The sender circuit 118 may be configured to generate a sender signal representing a volume of fluid in the fluid container in response to the angular-level measurement and the pressure. In one embodiment, volumetric values for levels associated with various container orientations/angles may be predetermined. Thus, a set of volumetric values may be determined for each orientation. The sender circuit 118 then uses the angular-level measurement to select an appropriate level-to-volume conversion table. In alternative embodiments, the volume may be calculated directly using a three-dimensional container model and the angular-level information, together with the pressure or liquid level information.

In still further embodiments, the sender circuit may include a calibration input for calibrating the pressure measurement. The fluid sender may be mounted to a container with the immersion tube extending into the interior of the container. The container may then be filled to a level designated as the “full” level. Momentary power may then be applied to the calibration input to indicate to the calibration input of the sender circuit 118. The fluid sender may include a switch that provides a ground voltage, but that when depressed provides a signal voltage to a calibration input of the sender circuit. In this way, the immersion tube may be configured to work after adjustment of the immersion tube length. That is, the immersion tube may be cut to a desired length, or it may be a telescoping tube with an airtight connection between the telescoping tube lengths, such as by a rubber seal, or an elastomer rated to work with fuels for fuel applications. The sender may then be calibrated as described above.

The sender circuit 118 may be configured to provide an output that conforms to standardized signal levels and/or digital communication formats, such as those specified by the Society of Automotive Engineers (SAE) (e.g., Truck and Bus Control and Communications Network Standards set forth in SAE-J1939; SAE J1810 Electrical Indicating System Specification), or by the National Marine Electronics Association (NMEA 2000).

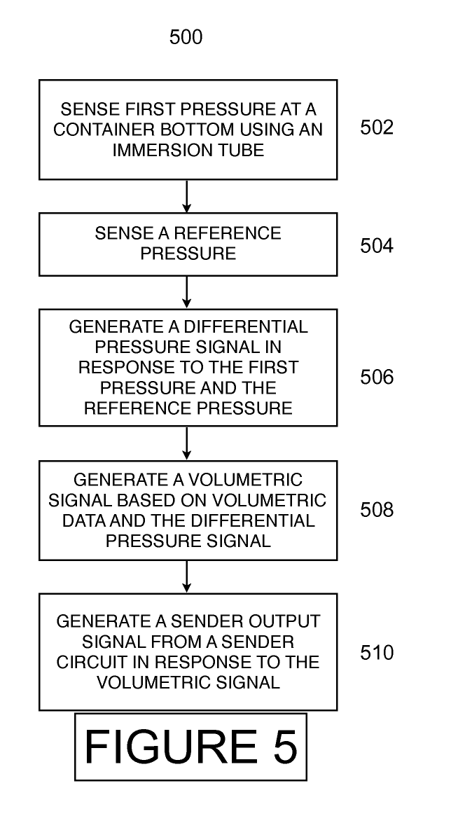

Embodiments described herein also include methods, such as a method 500 set forth in FIG. 5. At block 502, a first pressure is sensed at a container bottom position at an interior portion of a fluid container using an immersion tube; at block 504, a reference pressure is sensed. At block 506, a differential pressure signal is generated in response to the first pressure and the reference pressure. At block 508, a volumetric signal is generated based on volumetric data and the differential pressure signal. At block 510, a sender output signal is generated from the sender circuit in response to the volumetric signal wherein the sender circuit is enclosed in a housing providing electrical isolation from the interior portion of the fluid container. In further embodiments, the sender circuit is configured to provide a supplemental output indicating a low fuel condition.

In some embodiments of the method, the sender output signal is representative of a fluid level and is generated by converting the differential pressure signal to a fluid level based on fluid-specific conversion data as described above. The volumetric data may also be container-specific volumetric data The method may further comprise obtaining an angular-level measurement wherein the sender output signal is generated in response to the angular level measurement.

As will be appreciated by one skilled in the art, aspects of the disclosed fluid sender technology may be embodied as a system, method or computer program product. The embodiments may differ in the allocation of functions between hardware and software (including firmware, resident software, micro-code, etc.). Regardless of the particular implementation, the embodiments may all generally be referred to herein as having a “circuit,” “module” or “system.”

As described above, some embodiments may take the form of a tangible computer program product embodied in one or more tangible computer readable medium(s) having computer readable program code embodied thereon. The computer readable storage medium includes at least the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

For aspects of the embodiments described above with reference to flowchart illustrations and/or block diagrams of methods, apparatus (systems) and computer program products, it will be understood that various blocks of the flowchart illustrations and/or block diagrams, and combinations of blocks in the flowchart illustrations and/or block diagrams, can be implemented by computer program instructions. These computer program instructions may be provided to a processor, microcontroller, ASIC, FPGA, or other programmable data processing apparatus to produce a machine, such that the instructions, which execute via the processor or other programmable data processing apparatus, create means for implementing the functions/acts specified in the flowchart and/or block diagram block or blocks.

It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved.

Note that the functional blocks, methods, devices and systems described in the present disclosure may be integrated or divided into different combination of systems, devices, and functional blocks as would be known to those skilled in the art.

In general, it should be understood that the circuits described herein may be implemented in hardware using integrated circuit development technologies, or yet via some other methods, or the combination of hardware and software objects that could be ordered, parameterized, and connected in a software environment to implement different functions described herein. For example, the present application may be implemented using a general purpose or dedicated processor running a software application through volatile or non-volatile memory. Also, the hardware objects could communicate using electrical signals, with states of the signals representing different data

It should be further understood that this and other arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions, or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “ a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A fluid sender device comprising:
a differential pressure transducer having a first pressure port and second pressure port, the differential pressure transducer configured to generate a pressure measurement;
an immersion tube having a first end coupled to the first pressure port and having a second end configured for receiving a pressure and communicating the pressure to the first pressure port;
a sender circuit connected to the differential pressure sensor, the sender circuit configured to provide a sender output that varies in response to the pressure measurement; and,
a housing configured to enclose the differential pressure transducer and the sender circuit, the housing further configured to provide electrical isolation between the first pressure port and the sender circuit, the housing having a mounting structure configured to mount the housing to a wall of a fluid container with the immersion tube extending into an interior of the fluid container.

2. The apparatus of claim 1 wherein the housing further comprises a reference passage configured to expose the second pressure port to a reference pressure.

3. The apparatus of claim 2 wherein the reference passage is configured to couple the second pressure port to the interior of the fluid container.

4. The apparatus of claim 2 wherein the reference passage is configured to couple the second pressure port to the exterior of the fluid container.

5. The apparatus of claim 1 wherein the sender circuit comprises a microcontroller having an analog input configured to accept a signal from the differential pressure sensor.

6. The apparatus of claim 1 wherein the sender circuit is configured to generate a sender signal representing a level of fluid in the fluid container.

7. The apparatus of claim 1 wherein the sender circuit is configured to store volumetric data corresponding to the fluid container and to generate a sender signal representing a volume of fluid in the fluid container based on the volumetric data and the pressure measurement.

8. The apparatus of claim 7 wherein the sender circuit comprises a look-up table configured to convert the pressure measurement to a volumetric value.

9. The apparatus of claim 1 wherein the sender output is a signal compliant with one of J1939, J1810, or NMEA 2000 standards.

10. The apparatus of claim 1 further comprising a level sensor mounted to the housing and connected to the sender circuit, the level sensor configured to provide an angular-level measurement to the sender circuit.

11. The apparatus of claim 10 wherein the sender circuit is further configured to generate a sender signal representing a volume of fluid in the fluid container in response to the angular-level measurement and the pressure. use a separate volumetric data set.

12. The apparatus of claim 1 wherein the sender circuit further comprises a calibration input for calibrating the pressure measurement.

13. The apparatus of claim 1 wherein the immersion tube has an adjustable length.

14. The apparatus of claim 1 wherein the sender circuit includes a fluid type setting. selector-dip switch to be read by the processor.

15. The apparatus of claim 1 wherein the housing structure comprises one of (i) a flange having an SAE 5 hole mounting pattern or (ii) a threaded 1½ NPT cylinder.

16. A method comprising:
sensing a first pressure at a container bottom position at an interior portion of a fluid container using an immersion tube;
sensing a reference pressure;
generating a differential pressure signal in response to the first pressure and the reference pressure;
generating a volumetric signal based on volumetric data and the differential pressure signal; and,
generating a sender output signal from a sender circuit in response to the volumetric signal wherein the sender circuit is enclosed in a housing providing electrical isolation from the interior portion of the fluid container.

17. The method of claim 16 wherein the sender output signal is representative of a fluid level and is generated by converting the differential pressure signal to a fluid level based on fluid-specific conversion data.

18. The method of claim 16 wherein the volumetric data is container-specific volumetric data.

19. The method of claim 16 further comprising obtaining an angular-level measurement wherein the sender output signal is generated in response to the angular level measurement.

20. The method of claim 16 wherein the housing includes a mounting structure, the mounting structure being one of (i) a flange having an SAE 5 hole mounting pattern or (ii) a threaded 1½ NPT cylinder.
